(19) United States
(12) Patent Application Publication
(10) Pub. No.: US 2006/0248341 A1
(43) Pub. Date: Nov. 2, 2006

(54) Secure access control method

(76) Inventors: Laurent Lambert, Paris (FR); Jean-Christophe Fondeur, Levallois (FR)

Correspondence Address: Gerald E Helget;Briggs and Morgan, 80 South Eighth Street, Suite 2200, Minneaplis, MN, 55402, US

(21) Appl. No.: 10/554,363

(22) PCT Filed: Apr. 14, 2004
(86) PCT No.: PCT/FR04/00922

§ 371 Date: Apr. 13, 2006

(30) Foreign Application Priority Data
Apr. 28, 2003 (FR) 0305153

(51) Int. Cl. H04L 9/00

(52) U.S. Cl. 713/182

(57) ABSTRACT

The present invention concerns a method of controlling access for a person comprising the taking of an identification measurement for a said person and at least one other measurement, the said method consisting of authorising access for the said person when he has been identified by the said identification measurement and the said identification has been validated by the said other measurement or measurements and refusing it in the contrary case. According to the invention, when the said person has been identified by the said identification measurement and inconsistency exists between at least two measurements, at least one characteristic of the said identified person is recorded in a revocation list, the said method also consisting of refusing access to any identified person where the said or one characteristic is recorded in the said revocation list.

The present invention concerns a secure access control method.

At the present time, controlling access to a protected place or to a computer system is essential. This access control is achieved by defining a list of authorised persons. Once the access parameters are recorded, the access control system allows access only according to information received in accordance with the previously established access conditions. This access control method generally comprises an identification phase and a verification phase. This method is hereinafter referred to as a consolidated identification method.

A consolidated identification method can for example be implemented using biometric means. This is the case, for example, with consolidated identification methods consisting firstly of identifying, by taking a fingerprint, the person requesting access and secondly verifying the living character of the finger carrying this fingerprint. A system of this type is, for example, in the form of fingerprint sensors comprising optical means designed to produce an image of a print and electrical means designed to make electrical measurements of the finger carrying this print. By means of a processing device attached to the sensor, the image of the print is compared with an image bank in order to identify the person owning the corresponding finger and the electrical measurements are compared with each other or with other characteristics extracted from the image of the fingerprint in order to check whether this finger is living.

By these two-phase consolidated identification methods, fraud attempts are limited. Nevertheless, it was found that the number of attempts reduced the reliability of the system, a fraudster who has succeeded in being identified as an authorised person being able, for example, to have this identification validated and thus get round the system after a few tens of attempts.

The aim of the invention is therefore to improve the security of the consolidated identification methods by preventing many attempts from making it possible to foil it.

To this end, the present invention concerns a method of controlling access of a person comprising the taking of an identification measurement of the said person and at least another measurement, the said method consisting of authorising access to the said person when he has been identified by the said identification measurement and the said identifications have been validated by the said other measurement or measurements and refusing it in the contrary case. The method according to the invention is characterised in that, when the said person has been identified by the said identification measurement and an inconsistency exists between these two measurements, at least one characteristic of the said person identified is recorded in a revocation list, the said method also consisting of refusing access to any identified person where the said or one characteristic is recorded in the said revocation list.

According to another characteristic of the invention, the said identification measurement is made by an identification means and in that the said or each other measurement is made either by an identification means or by a measuring means.

According to another characteristic of the invention, an identification means is chosen from amongst means of recognising a fingerprint, iris, voice or secret code and in that a measuring means is chosen from amongst means of measuring impedance, inductance, blood pressure or temperature.

According to another characteristic of the invention, the said method consists of comparing the measurement results obtained by the said or each identification means with pre-established data and identifying a person when the measurement results correspond to pre-established data for the said person.

According to another characteristic of the invention, the said method consists of validating an identification of a person when the measurement results obtained by the said or each measuring means corresponds to acceptability criteria.

According to another characteristic of the invention, the said method also consists, before refusing access to an identified person where the said or one characteristic is recorded in the said revocation list, of making at least one other identification measurement, referred to as the second identification measurement, and allowing access to the said person when the results of the said or each second identification measurement corresponds to the result of the said first identification measurement and refusing access in the contrary case.

According to another characteristic of the invention, the said characteristic recorded in the said revocation list is at least the result of a measurement allowing identification or information deduced from the said result.

According to another characteristic of the invention, the said information is the identity of the identified person.

The characteristics of the invention mentioned above, as well as others, will emerge more clearly from a reading of the following description of an example embodiment, the said description being given in relation to the accompanying drawings, amongst which:

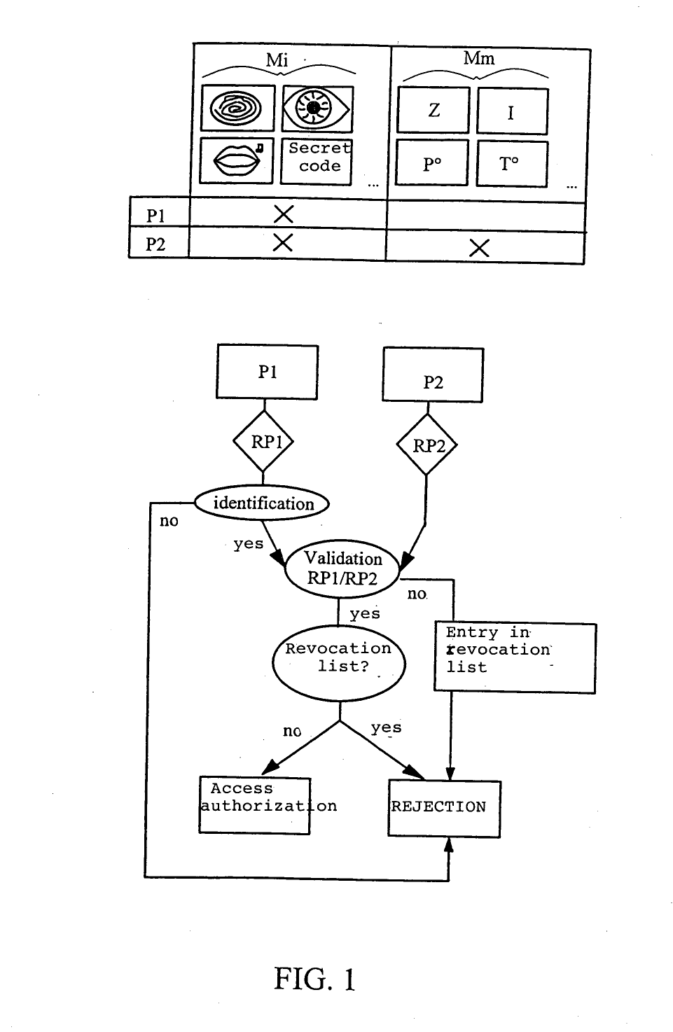

FIG. 1 depicts a flow diagram of the steps of the consolidated identification method according to a first embodiment of the invention.

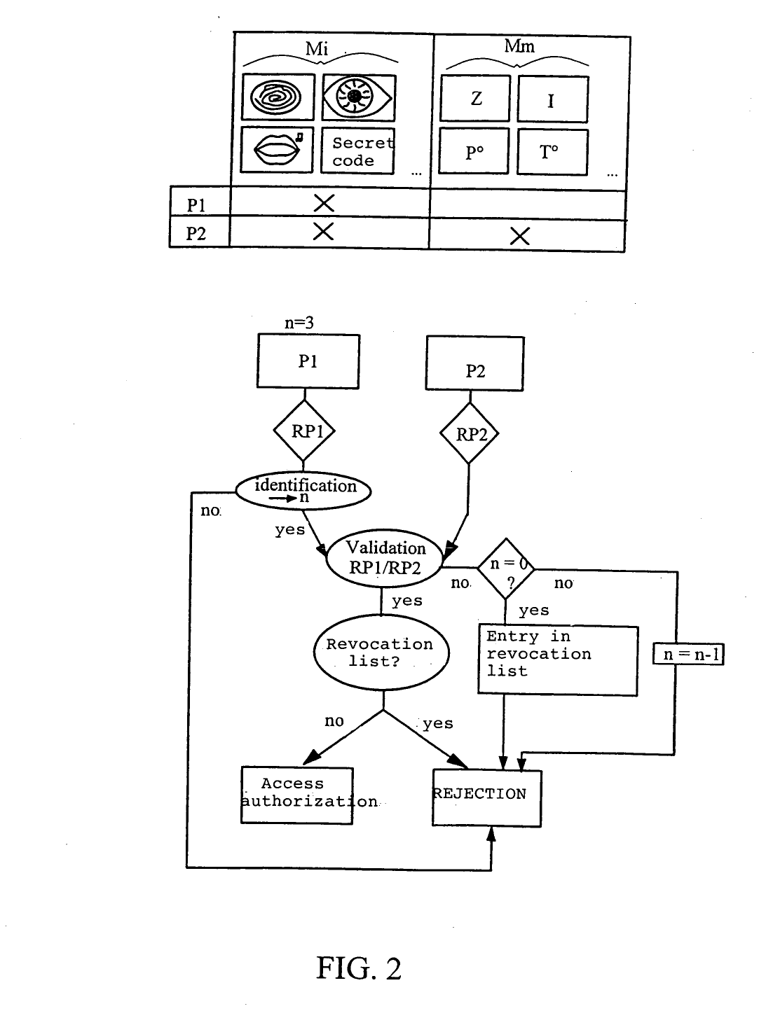

FIG. 2 depicts a flow diagram of the steps of the consolidated identification method according to a second embodiment of the invention.

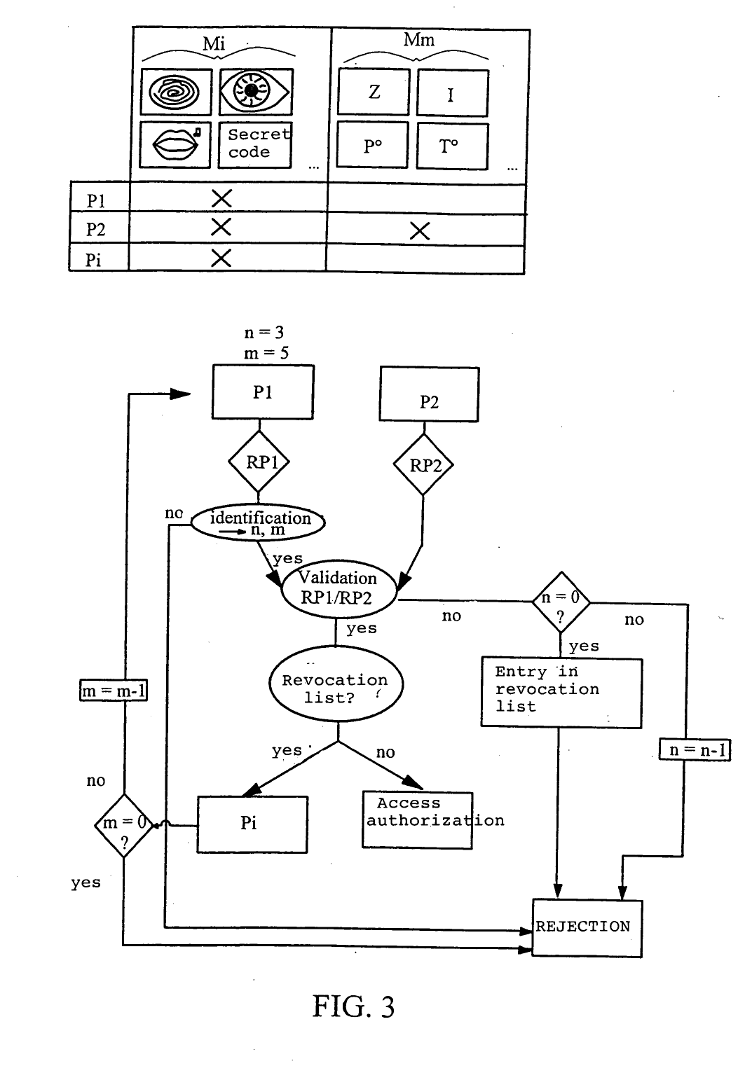

FIG. 3 depicts a flow diagram of the steps of the consolidated identification method according to a third embodiment of the invention.

The method according to the invention is an access control method based on the principle of a consolidated identification method. The consolidated identification method illustrated in FIG. 1 comprises a set of measurement taking means grouping together identification means Mi designed to identify a person requesting access to a system, and measuring means Mm designed to make measurements on this person requesting access in order to characterise him.

An identification means Mi is for example a fingerprint sensor, an iris sensor, a voice sensor or a device for inputting a secret code, etc. A measuring means Mm is for example a sensor making measurements of impedance Z, inductance I, blood pressure P°, temperature T° or any other characteristic relating to the person requesting access.

In the method according to a first embodiment of the invention, the first step consists of making at least two measurements P1 and P2. One of the measurements, for example P1, is necessarily a measurement performed using an identification means Mi, whilst the other measurement P2 and the other measurements if others exist are each performed using a means chosen from amongst all the identification means Mi and all the measuring means Mm proposed previously. Thus it is possible to effect at P1 the taking of the fingerprint and at P2 the taking of an iris pattern or, at P1 the taking of a fingerprint and at P2 the making of an optical measurement, etc.

It is also possible to effect at P1 the taking of a fingerprint from the thumb of the right hand coupled at P2 with impedance measurements on this thumb.

It should be noted that the measurements P1 and P2 can be made both successively and approximately simultaneously. In the case of two successive measurements, these measurements are connected together by an order relationship and/or a time relationship logic. Thus, for example, when a group of authorised persons makes the two measurements P1 and P2 in two successive steps, each person is recognised at the second measurement P2 as being the person already recognised at the first measurement P1.

Each measurement P1, P2, gives a result RP1, RP2. The result RP1 obtained by the measurement P1 intended to identify the person requesting access is subjected to a so-called identification step. This step consists of verifying that the result RP1 corresponds to an authorised person. If at the end of the identification step the response is negative, or in other words if the person requesting access has not been recognised as an authorised person, then access for this person is immediately rejected. If in the contrary case the person requesting access has been recognised as an authorised person, the results RP1 and RP2 of the two measurements P1 and P2 are subjected to a validation step. This step consists of verifying that there exists consistency between the results of the measurements RP1 and RP2. Consistency means in general terms the establishment of an expected relationship between the results of the measurements RP1 and RP2.

In an illustrative embodiment, the result RP1 is considered to be good if there is identification, that is to say if the system recognises that the print of the right thumb of the person requesting access corresponds to a print of an authorised person. The result RP2 is considered to be good if the impedance values measured on the right thumb correspond to values considered to belong to a living person. Finally, the consistency of the results RP1 and RP2 with each other is verified and considered to be good if the thumb carrying the recognised print has measured impedance values considered to belong to a living person or pre-recorded values considered to be peculiar to the person identified.

If the identification and consistency conditions are not validated, then access is refused to the person requesting it. This rejection is also the subject of an entry in a so-called revocation list, of at least one characteristic identified during the taking of the measurement P1. This or these characteristics can be a result of the taking of a measurement or information derived from a result of the taking of a measurement. Thus, amongst the characteristics that can be entered in the list, there can be found, for example, the identity of the person recognised, a fingerprint, a secret code, etc. This or these characteristics can be those of the victims of fraudsters or those of fraudsters. This or these characteristics must make it possible to more easily recognise the fraudster during a new attempt by him.

On the other hand, if the identification and consistency conditions are validated, then it is verified that at least one of the characteristics issuing from the measurements and liable to be in the revocation list are not found in this revocation list. If no characteristic issuing from the measurements and liable to be in the revocation list is present in the revocation list, then access is authorised. If in the contrary case at least one characteristic issuing from the measurements is present in the revocation list, then access is refused to the person requesting it.

If, for example, the print of the right thumb taken during the measurement P1 validated by a measurement P2 is, after consultation of the revocation list, already recorded in this list, the person requesting access with this print is immediately rejected.

Once the revocation list is set up, any person presenting themselves to the measurements P1 and P2 with one of the characteristics entered in the revocation list, this person being able to be either the person holding this identify or a fraudster, will routinely be refused access. Access is thus made very difficult to fraudsters making several attempts.

In a second embodiment of the invention illustrated in FIG. 2, a predefined number of access attempts n is established. This predefined number is, for example, three. In this embodiment, the steps preceding the validation step and the steps following the acceptance of the validation are identical to those described for the first embodiment. On the other hand, in this embodiment, in the absence of validation, it is verified that the number of attempts n is different from a zero value. If this is the case, the number of attempts n is decremented by one unit and access for the person requesting this access is rejected. If such is not the case, that is to say if this number n is equal to a zero value, then, like the first embodiment, at least one characteristic issuing from the measurements P1 and P2 is entered in a revocation list, and then access for the person requesting it is rejected. In addition, at each new access attempt, after identification of the person, the number of attempts n associated with the said person is obtained by relationship with this identification and is stored in order then to be taken into account in the case of absence of validation.

In this embodiment, the access attempts are counted up and the absence of validation sanctioned at the end of the predefined number of attempts by entry in the revocation list.

A third embodiment of the invention is also proposed. In this embodiment illustrated in FIG. 3, a characteristic that is identified and then validated but present in the revocation list is not the subject of routine rejection.

This is because the presence of this characteristic in the revocation list is followed, in this embodiment of the invention, by a new measurement Pi by an identification means Mi, different from the first measurement P1. This other measurement Pi replaces the first measurement P1 obtained by an identification means. The method recommences at the start and the various steps of the method take account of the results obtained by the measurements Pi and P2.

In the illustrative example chosen, if the print of the right thumb is present in the revocation list, the person requesting access can make a new measurement, either with an identical identification means Mi, but for example with the index, or with a different identification means Mi, for example with the pattern of the iris of his right eye, etc.

It should be noted that the choice of the new identification means Mi can either be left to the person requesting access or be proposed by the system implementing the method.

In the illustrative example chosen, the presence in the revocation list of the thumb print identified when the measurement P1 is made may be the subject of another measurement by an identification means Mi such as, for example, an iris reading. The pattern of the iris then replaces the thumb print in the method.

In order to limit the number of identification attempts, a number of identification attempts m is predetermined. In this way, after each change of identification means, it is verified that the number of identification attempts m is different from a zero value. If this number m is different from a zero value, then this number m is decremented by one unit and the method is recommenced, otherwise access is rejected.

Likewise, like the second embodiment, the validation step is followed by a verification of a number n of predetermined attempts resulting either in an immediate rejection in the case where n is different from zero, or in an entry in the revocation list and rejection in the contrary case.

It should be noted that values of m and n are known at the identification step because of the match made between the identity of the person and the number n or m.

For each of the embodiments disclosed, the person recognised through the rejected characteristic must then be re-authorised in a controlled manner in order once again to be considered and recognised by the system as a person authorised for access. This re-authorisation can be obtained by two methods. The first method consists of deleting from the revocation list the characteristics relating to the said person and then re-validating them so that they are once again recognised as belonging to an authorised person. The second method consists firstly of definitively eliminating authorisation to the said characteristics entered in the revocation list and secondly authorising other characteristics relating to the said person not entered in the revocation list.

It should be noted that the information contained in the said revocation list can be centralised in a computer file that can be consulted remotely by the system responsible for communicating with the said list.

1-8. (canceled)

9. A consolidated identification method for a person, comprising authorizing access for the person, further comprising the following steps:
(a) taking an identification measurement for the person performed by an identification means (Mi);
(b) at least one other measuring step;
(c) identifying the person subjected to the identification measurement;
(d) validating the identification method by the at least one other measuring step;
(e) verifying that at least one characteristic of the person issuing from the measuring steps does not belong to a revocation list;
(f) if at least one characteristic of the person issuing from the measuring steps belongs to a revocation list, executing step (a) with a different identification means (Mi) and then re-executing steps (b) through (f); and
(g) allowing access if steps (a) through (f) are successful.

10. A method according to claim 1, further comprising the step of entering at least one characteristic of the person in a revocation list when, after a predefined number of unsuccessful access attempts, an inconsistency exists between two measurements.

11. A method according to claim 1, wherein each measurement step is performed either by an identification means (Mi) or by a measuring means (Mm).

12. A method according to claim 1, wherein an identification means (Mi) comprises recognizing a member selected from the group consisting of: a fingerprint, an iris, a voice, or a secret code; and wherein a measurement means (Mm) comprises measuring a member selected from the group consisting of: impedance Z, inductance I, blood pressure P⁰ or temperature T⁰.

13. A method according to claim 1, wherein the identification step further comprises comparing the measurement results (RP1, RP2) obtained by the identification means (Mi) with pre-established data and identifying the person when the measurement results (RP1,RP2) correspond to the pre-established data for the person.

14. A method according to claim 1, wherein the validation step further comprises comparing the measurement results (Rp1, RP2) obtained by each measuring means (Mm) with pre-determined values corresponding to acceptable criteria.

15. A method according to claim 2, wherein the characteristic recorded in the revocation list is at least the result of a measurement permitting identification or information derived from the result.

16. A method according to claim 7, wherein the information is the identity of the person identified.
